(19) United States
(12) Patent Application Publication
(10) Pub. No.: US 2002/0049689 A1
(43) Pub. Date: Apr. 25, 2002

(54) Systems and methods for visual optimal ordered knowledge learning structures

(76) Inventor: Srinivas Venkatram, Mumbai (IN)

Correspondence Address: Rashida A. Karmali, Suite 1000, 230 Park Avenue, New York, NY, 10169, US

(21) Appl. No.: 09/902,067

(22) Filed: Jul. 10, 2001

Related U.S. Application Data
(60) Provisional application No. 60/242,389, filed on Oct. 20, 2000.

(51) Int. Cl. G06F 17/00

(52) U.S. Cl. 706/45; 707/100

(57) ABSTRACT

The Visual OOKS technology of the present invention comprising an Access Interface, which presents the user's needs and environment in terms of specified goals, outcomes and other related information, a plurality of user interfaces in which learning structures are embedded as navigational and organizational elements, and which are selected and presented to the user on the basis of the users specification of outcome or task goals, and further comprising of a retrieval engine and a tagged database such that the retrieval engine is able to select the appropriate knowledge object from the tagged database, logically organize them, and present to the user in terms of learning structure which has been prior presented to the user. The Visual OOKS platform may have an additional layer for appropriate visual presentation of the document. The Visual OOKS platform uses a unique Universal Classification Knowledge Framework (UCKF).

### 1. FIELD OF THE INVENTION

The present invention relates to Visual Optimal Ordered Knowledge Systems (Visual OOKS) and methods and more particularly to a learning integrator comprising of a “dothelp” platform and a “user centric search engine” which filters knowledge retrieved from different databases and integrates it into interlinked concepts and paths. The learning integrator organizes, orders and delivers optimal meaningful content in response to a specific knowledge request.

### 2. BACKGROUND OF THE INVENTION

The Internet has opened up the opportunity for on-line and low cost worldwide distribution of learning materials to users. Almost every single knowledge management initiative, whether in commercial, educational or personal context attempts at least in part to bring the knowledge base close to the actual tasks being carried out by the user. In other words, the goal is to seek “just-in-time knowledge”. A major challenge lies in making use of Internet technology to deliver highly customized, ordered and optimal knowledge to each individual user. For example, in the case of customized training, each user should be able to read, interact with and/or download materials, which address the user's needs as a function of the user's current level of learning. Existing systems for collecting and managing information have been inadequate to meet such needs because they do not provide for effective assessing, evaluating and updating of information or knowledge needs within an organization or system. In other words, existing systems do not adequately address the accrual of knowledge resulting from activity concerning the user's needs as determined from a variety of perspectives, which is an important aspect of succeeding in the electronic global environment.

As current information sources become larger and more complex to serve a variety of knowledge workers with particular information needs, providing knowledge workers within an organization with customized knowledge becomes increasingly important to the success of any organization. The problem lies first in the ability of the knowledge workers within the organization to clearly specify their knowledge requirements. Second, the overwhelming abundance of knowledge that is available in different forms and the resulting inability of knowledge managers to meaningfully package and provide the appropriate or optimal knowledge which may be in the form of documents, information bytes, video or sound, to the knowledge workers. According to the present invention, the problems and disadvantages with existing knowledge management systems and methods have been substantially eliminated.

### 3. SUMMARY OF THE INVENTION

According to a broad aspect of a preferred embodiment of the invention, a plurality of systems called collectively the Visual OOKS technology is provided which processes knowledge to customize or optimize content for a specific user.

Visual OOKS is a method by which (1) an existing knowledge base may be classified or accessed in terms of a universal knowledge classification system (2) a set of visual structures are used to describe to the user a set of criteria to be used to select from the knowledge base a relevant set of documents (3) a retrieval mechanism that allows for the appropriate documents to be selected and linked together.

The universal classification system is a fundamentally new paradigm in the classification of knowledge and knowledge products such as documents, films, etc. The classification system is built on a system of tagging individual documents in terms of the purpose or use of the document in addition to any other ‘information specific’ characteristic such as subject classification. A document may have a numerous tags or sets of tags or combination of tags that allow for multiple utilization of the same content in numerous knowledge or content access situations, e.g., a classification framework that we have used in a preferred embodiment described below is <seeker, context, concept, knowledge path>.

The set of visual structures used to specify the users requirement are developed on the basis of providing (1) logical access to a body of knowledge (2) offer groups of choices within a logical structure or user context in order to enable highly sophisticated filtering by the user in terms of the users own context or characteristic. The visual structures themselves are built on the unique ‘learning structure’ paradigm.

The retrieval engine builds the link between the users preferences for knowledge as defined within the logical or visually coherent structure presented to the user and the knowledge base described above. The retrieval engine may set up the documents' search characteristics for the purpose of selecting the appropriate document either in terms of the information fully provided by the front-end navigational/visual structures or in terms of additional taxonomies and knowledge architecture which it may refer to for a specific body of users.

One of the key features of the visual OOKS methodology is that it allows for on going classification of a growing knowledge base and the simultaneous and concurrent creation of numerous user centric visual structures within a single retrieval framework and a limited set of retrieval engines.

Another key feature is that it allows for the logical structuring of knowledge documents or knowledge packets in response to specific requirements or answer criteria. This is distinct from the visual structuring or formatting of a body of knowledge in terms of the presentation and organization of ‘blocks’ of information.

Yet another key feature of the Visual OOKS methodology is that it allows for knowledge to be integrated into multiple media documents within a single logical framework and a single classification or access paradigm. This allows for the integration of multiple databases and the simultaneous and multi-contextual use of documents within one or more of these numerous databases in such a manner as to allow for the custom creation of unique new content or delivery ready documents in numerous different media and delivery formats.

The central notion of the Visual OOKS technology is that content structures are of two kinds—those that are devised from the subject matter itself, the domain structures, and those that are driven by the learning structures which are derived from the use of the subject matter. The paradigm allows the isolation and development of learning structures, which enable effective custom structuring, and provides simultaneous solutions to problems of “repurposing” and “cross media integration”.

According to another aspect of the Visual OOKS technology, the invention comprises the concept of learning structures representing knowledge concepts and paths relevant to a particular user situation, such knowledge paths being linked to each knowledge concept.

The present invention provides a universal knowledge classification framework that allows use of an individual document and/or parts thereof, to be used in a plurality of logical structures and be presented to different users in various forms, ways or elements with one or more knowledge packets.

The Visual OOKS technology of the present invention comprises a plurality of user interfaces in which learning structures are embedded as navigational elements and/or selected by the user, and further comprises a retrieval engine that translates the user choice made into a search for all documents that meet the criteria and subsequently fits the documents into the logical relationships established by the learning structure. The Visual OOKS platform may have an additional layer for visual presentation of the document.

A specific embodiment of Visual OOKS technology includes the “dothelp” platform. The “dot help platform” is a generic version of the specific manifestation called “ownbiz” described below.

Yet another embodiment of Visual OOKS technology includes the “personal” search engine.

Other important technical advantages are readily apparent to those skilled in the art from the following figures, description and claims.

### 4. BRIEF DESCRIPTION OF THE FIGURES

For a complete understanding of the present invention and for further features and advantages thereof, reference is now made to the following descriptions taken in conjunction with the accompanying drawings in which:

FIG. 1 is a schematic representation of the learning structure. As can be seen from the figure, a learning structure is a purposive concept map comprising of three key components—(i) a clearly specified outcome around which (ii) a set of concepts are uniquely defined (concept 1), (iii) with each concept being populated by a set of concepts uniquely defined (concept 2) with each concept being populated by one or more learning paths. Of these components (i) and (ii) are necessary for a learning structure to exist, while (iii) need not be sharply defined in all cases.

FIG. 2 illustrates an embodiment of the learning structure. The outcome is defined in terms of a specific question to be answered. Each of the concepts defined in this structure refers to the steps involved in logically and sequentially answering this question. The learning paths are described as “codes” on each content option available to the viewer and provide the users with additional information on quickly selecting the appropriate knowledge needed.

FIG. 3 illustrates the differences between the organization of ideas in a concept map and in a learning structure.

FIGS. 3.1 and 3.2 illustrate one example each of a concept map and a mind map (both commonly known techniques for learning/knowledge management, etc).

FIG. 3.3 illustrates the organization of a learning structure for the same topic area as 3.1. The figure indicates that a learning structure is purposive with concepts defined in relation to the purpose.

FIG. 4 is a block diagram representing the presentation interface, retrieval engine and tagged documents based on universal classification knowledge framework.

FIG. 5 illustrates the Access Portal navigation for the embodiment OwnBiz.help.

FIG. 5.1 illustrates the ‘Areas of knowledge help’ being sought by the seeker of knowledge. These areas of help needed are described in terms of the area of operation of the individual followed by the kind of problem, symptom/event being encountered or the action help sought by the seeker of knowledge.

FIG. 5.2 illustrates the ‘Access Screen’ for knowledge for a particular action help ‘Controlling Inventory’. The access to knowledge for this action help is through a number of ‘How to . . . ’ or ‘What if . . . ’ questions.

FIG. 6 illustrates the Learning Structure navigation for the embodiment OwnBiz.help.

FIG. 6.1 illustrates schematically the operation of the learning structure display.

FIG. 6.2 illustrates the ‘Answer’ to the ‘How to . . . ’ question posed in FIG. 5.2. The ‘Answer’ is presented in the form of a template, which presents the various elements of the answer along with access to choice of documents that describe each element in greater detail.

FIG. 7 illustrates the access portal of the ‘user centric’ personal search engine embodiment of Visual OOKS

FIGS. 7.1 and 7.2 illustrate the following: (1) the user is able to make a choice of ‘Role’ described in the figure as ‘Choose User Profile—Image Designer’ (2) the user is then offered a set of choices of the type of work or information need contexts relevant to the user in the section ‘Need Specifier’ (3) the user may be provided additional resources for making more informed information choices or developing an appropriate search strategy in the section ‘Personal Resource Map’.

FIG. 8 illustrates

(i) the set of choices offered to the ‘seeker’ on the basis of his selection in the ‘Need Specifier’ section in the previous figure. This set of choices is built on the dimensions of knowledge needs for a specific activity or unit of knowledge work.

(ii) illustrates the response to a choice made among the dimensions of knowledge needs in the access portal screens. The user is provided with a pattern seeker engine which presents a set of document choices (with associated web or computer system addresses such as—file names, URLs). The user is also provided with additional relevant information that can enable better choice of appropriate documents. The user is also provided with a facility to select the documents most ‘valid’ or relevant to the user's current search activity. The pattern seeker engine identifies the relevant concepts being selected by the user (on the basis of implicit learning structures embedded in the checklists) and then uses this information to specify further concept-based searches using conventional search engine technology.

The selected documents thus act as the basis for the system to identify ‘key words’ or other search criteria that are ‘fed’ or sent to other search engines or document retrieval systems. The system collects and presents all documents which meet these criteria. The user thus has the opportunity to access numerous additional documents that most nearly ‘fit’ the user's current needs without having to go through the process of specifying search criteria in terms of search engine queries, index choices, etc.

FIG. 9 illustrates a block diagram describing the search engine embodiment in its various components. The retrieval engine performs the function of not only providing relevant documents to the user, but also provides the user with an implicit learning structure which directs further more refined searches.

This is superior to existing search technologies because the retrieval engine is, in the 1st round of retrievals (from the tagged database) enabling the user to enhance his/her understanding while selecting the appropriate documents and uses this refined selection, on the basis of this enhanced understanding, to carry out further searches.

This makes this a search engine that is continuously enhancing the understanding of the information seeker and is continuously refining its offering of new understanding to the user (as embodied through additional learning structures). The power is further enhanced because the search engine is also ‘aware’ of the concepts being selected by the user and therefore carries out more refined Internet based searches by connecting up to conventional search engines. This is an ‘n-dimensional’ concept map in action.

### 5. DESCRIPTION OF THE EMBODIMENT

The Internet has opened up the opportunity for on-line and low cost distribution of learning materials to users around the world. One of the central challenges and opportunities lies in making use of internet technology to deliver highly customized knowledge to each individual user, for example in the case of customized training, each user ought to be able to read, interact with and/or download materials which address his/her current state of learning, using learning methods (such as examples and case studies which are directly relevant to that person's context and, finally, allowing the user to be able to “feed back” into the system so that the system is able to redefine and configure new materials taking into consideration the fresh level of understanding of the user. This may be defined as the problem of ‘custom structuring’ of learning content or knowledge. It must be emphasized that this problem is distinct from the more widely addressed aspect of allowing users to pick and choose their material, set up preferred formats and offering up choices to users on the basis of their past interaction with the system.

The problem of ‘custom structuring’is closely related to two other significant challenges in the field of knowledge management and publishing: (a) the problem of re-purposing existing material and (b) the problem of integration of content across media—a central concern in the area of convergence of distribution technologies like the internet, or broad band television.

The problem of re-purposing is derived from the emergence of new modes of knowledge distribution. The emergence of the internet, for example, has resulted in publishers and corporate/university trainers commissioning fresh web ready content. On the other hand, there is a huge amount of training and educational material, which has already been created and delivered through traditional book publishing. A method that would allow selective but effective re-use of traditional materials for delivery in new media would therefore significantly reduce content development costs and result in better yields on existing publishing and knowledge assets.

The problem of content integration is closely interlinked with the above problem. Each new medium has resulted in the development of specific and ‘appropriate’ means of presentation. For example, educational CDs are organized in a totally different way from books or web materials. This has a serious implication on training strategies. Since each of these materials is independently prepared with widely differing formats, teachers and trainers have been unable to integrate all these media into a comprehensive and positively reinforcing ‘suite’.

The present invention provides platforms and methods for organizing and delivering content, which meaningfully addresses the above problems, and in particular, through the notion of learning structures. So far, the basic approach followed by various developers of learning content has been to identify the interrelationships between the ideas within the subject matter (domain knowledge structure) and then evolve the best way of presenting this subject matter in a particular medium. This has meant that content for a particular medium is developed jointly by experts in the subject and people with expertise in the medium of presentation. All this has resulted in the development of learning content becoming a craft based activity, highly dependent on the individual capabilities and orientation of the ‘creators of content’. This approach has had an important implication of making content development a highly labor intensive process and therefore the cost of developing new content or customizing content for a specific group of users has been expensive.

The present invention employs content structures of two kinds—those that are developed on the basis of the subject matter itself and those that are driven by the ‘learning context’. To differentiate them they are called ‘domain structures’ and ‘learning structures’. The domain structures are derived from within the subject matter, but the learning structures are derived from the use of the subject matter.

Almost all efforts so far have assumed that the learning structure is inherent in the medium. The methodology proposed by us focuses on the isolation and development of learning structures, which enable effective ‘custom structuring’ and the simultaneous solution to the problems of re-purposing and cross media integration.

Development and Application of Learning Structures:

A learning structure may be defined as a generic architecture, which describes or visually presents the manner in which different pieces of content may be tied together and presented so that this new body of content becomes specifically useful to a specific group of users.

For example, it would be useful to have a learning structure that describes how a business event such as a ‘high inventory costs’ may be traced back into causes which may lie within the marketing, finance or even the purchasing departments. This implies that content related to a discussion and potential solutions of this problem may be drawn upon from multiple disciplines, but in the real life context may prove to be far more useful than a simple presentation of information which may not enable the user to tie in, conceptualize and use effectively content which may or may not be familiar to user.

This may be a case where the learning structure is uniquely defined for a particular situation. There are also cases where the learning structure could be far more generic and usable in a set of similar situations. For example, a learning structure that describes how a new procedure is to be adopted within the company can be defined almost in terms of a ‘logic template’ with all the elements related to adoption within the company being logically tied in within the structure.

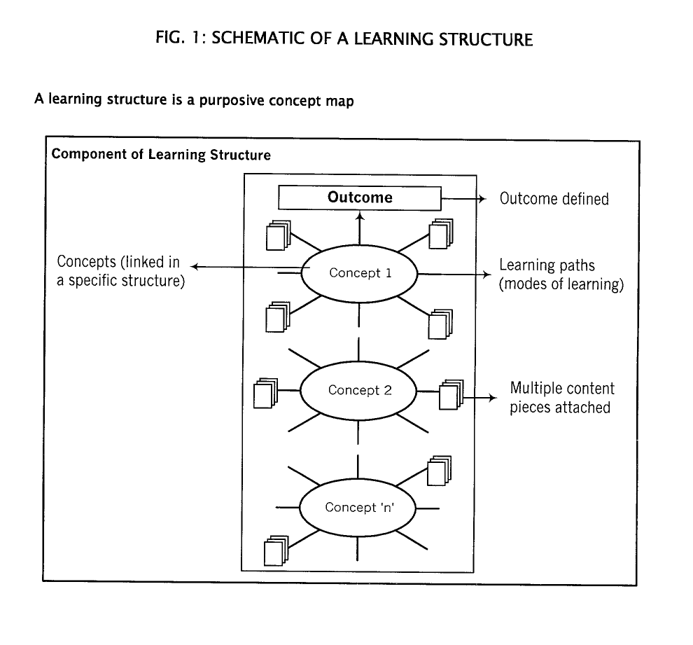

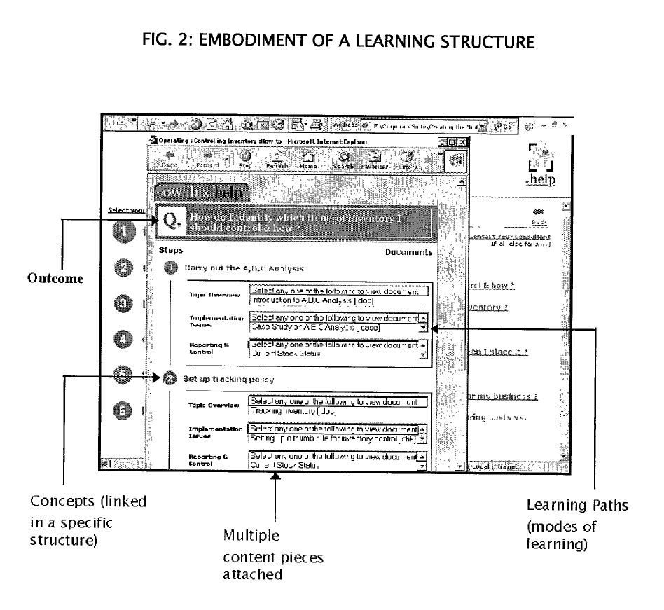

Similarly, in the case of learning structures designed for the transfer of conceptual knowledge to corporate executives: the elements of the conceptual or decision frameworks may be populated by critical insights or ideas which the learner must ‘get’. The learner then reads the insight and tries to grasp it and learn how to apply it by reading or working on the support cases, examples, or problems. Each of these cases is accessed from the domain knowledge base as a learning object and ‘fitted’ into this learning structure as a learning path for that specific insight or learning idea. The learning structures also focus on what people do with knowledge. They must therefore indicate not only how ideas must be connected to each other, but also how related content is drawn upon and connected to these ideas. (See FIGS. 1 and 2).

Re-organizing Domain Content Around Learning Structures; the Notion of Object Oriented Knowledge Systems.

A learning structure provides the architecture through which various learning elements, ‘ideas’, cases, or examples from within a domain are viewed. Therefore, any learning structure may therefore make use of a wide range of knowledge objects and that each knowledge object can be used differently in various learning structures to enable communication or assimilation of different ideas, depending upon the focus and purpose of that learning structure. This leads to the notion of ‘object oriented’ or “optimal ordered” knowledge management. This notion implies that any domain of knowledge can be disaggregated into inter-relationships between ideas and learning objects. The inter-relationship between ideas is captured within an appropriate learning structure (thereby giving a purpose to that knowledge) and the learning objects from within the domain are drawn up to populate the learning structure and make it useful for a specific audience or even a specific user.

The notion of breaking up a subject matter into fragments or knowledge objects becomes valuable if and only if there is a corresponding method of classification and tagging of these objects in such a way that an object can be relevantly placed in more than one learning structure. In other words there ought to be a set of learning structures (which may increase in time depending upon various situations and user groups) and a set of knowledge objects, which are classified in a universal manner so that the use of technology can enable appropriate ‘fitting together’ of structures and objects across situations.

The importance of the above idea cannot be over-emphasized. There exists numerous websites and knowledge databases where the underlying document base is organized into the most appropriate manner so that the relevant documentation for a specific user request or screen format is efficiently retrieved. What does not exist is a manner whereby a body of knowledge objects can be seamlessly used across various formats and knowledge use situations with the use of a single retrieval paradigm.

The present invention provides the Visual OOKS system of learning structures and classification of knowledge objects, which allow the seamless ‘packaging’ of documents and appropriate presentation (in terms of relationship of ideas' and not just ‘content formats’) and ultimately results in the development of a ‘universal code’ for classification of knowledge documents and objects.

Three novel systems of the present invention include: (1) the universal classification knowledge framework (UCKF) and (2) the learning structure. (3) The Access Portal. The UCKF forms the basis for tagging documents. The learning structure formats a set of documents or parts thereof into a meaningful whole unit on the basis of the relationship of the ideas rather than the commonly used publishing format. The access portal helps identify the user's requirement in terms of a specific outcome around which a learning structure is organized. The specification of outcome is crucial because it allows the scalability and efficiency of system design by finding common outcomes being sought across apparently diverse situations.

Visual OOKS is a system comprising of a knowledge router. The knowledge router selects documents on the basis of the UCKF and organizes them into meaningful whole units (on the fly) by using the learning structure.

The UCKF of the present invention thus provides a system for knowledge access in any kind of knowledge management or mining situation. The UCKF comprises of the seeker, the context, the concept or the knowledge path. Each of these parts represents one of the four critical steps in the information access and assimilation process. The seeker and context identify the outcome being sought and therefore the relevant learning structure being sought. The concept and knowledge path enable appropriate placement of a document within a specific learning structure. Each document or information object can be fitted into numerous learning structures. Each learning structure ties up objects from multiple information sources.

The four parts are further represented in a unique tagging system that is represented as <seeker, context, concept, knowledge path>. Each of the four elements may further be represented by one or more words.

The tagging system of the present invention is unique in combining the four elements and combining the information access and the information assimilation processes. Importantly, the tags in the present invention represent both the user and the knowledge base, therefore providing tacit knowledge.

The learning structure of the present invention carries out “logical” formatting by building a novel set of concepts and knowledge paths that are not domain centric but user (outcome) centric.

Visual OOKS Technology

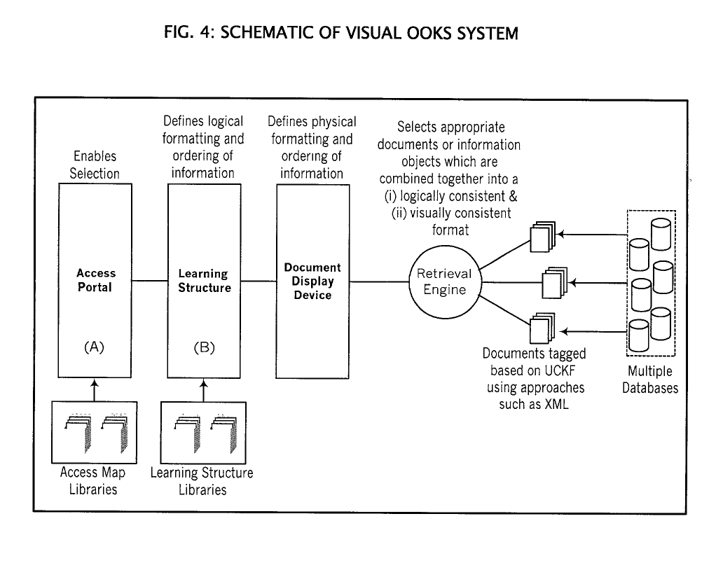

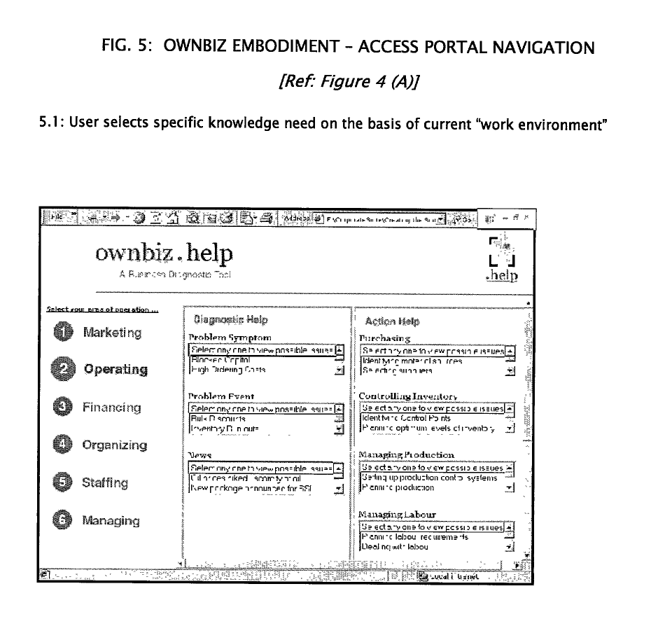

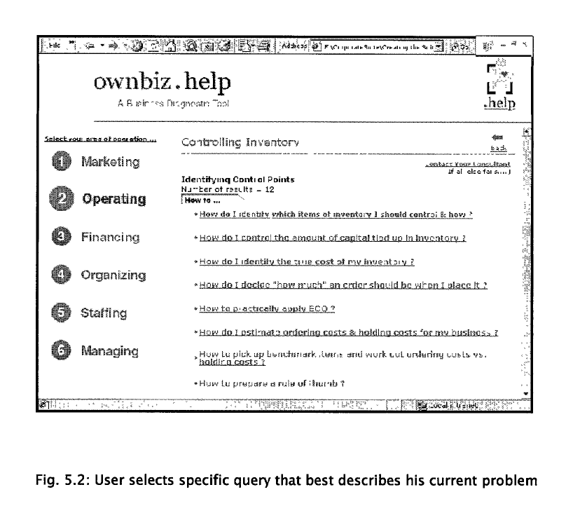

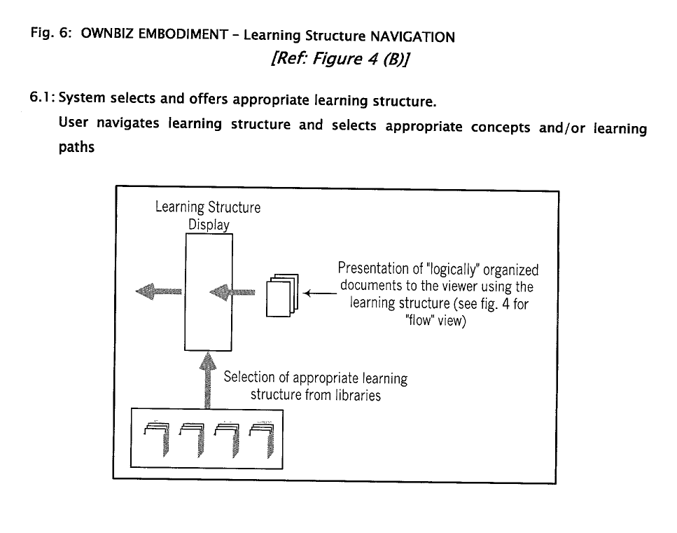

The Visual OOKS Technology comprises of the following components (See FIG. 4)

(a) An access portal which enables users to quickly select their specific knowledge need. The access portal may be a list of queries or a list of topics placed in context or even a key word based search engine. The critical difference is that the access Portal enables a clear articulation of the user's real-life outcome. This is a unique feature of the Visual OOKS system.

(b) The learning structure, which presents the organization of knowledge needed to reach the outcome. As can be seen, each outcome has prior specified learning structure, which is selected from a learning structure library and presented to the viewer. It is also possible for the learning structure to be organized into families such that groups of questions may have similar organization of concepts. This allows for more efficient use. Learning structures are built to fit a wide range of knowledge use situations, and also have common properties in order to be able to appropriately define knowledge objects. The basic ideas used to develop a learning structure are the notions of (i) outcome, (ii) concepts and (iii) knowledge path. The outcome defines the learning structure. The scalability of the technology lies in the selection of common outcomes that need generic or families of learning structures. For example, a ‘what if’ will usually have a generic structuring of ideas in order to meet the outcome. All learning structures are designed or formulated or evolved as structures of concepts with each concept tying together one or many knowledge objects in a specific knowledge relationship. The manner in which documents or document sets (knowledge objects) are tied together around or to the concept are defined as ‘knowledge paths’. The knowledge path thus represents the “mode” of access of knowledge which in the case of learning materials will be the “type of learning” the document offers but in the case of other knowledge aggregators is on the “type of content/media”.

(c) The Document Display device. This is an optional component in the system. It performs the function of formatting and physically modifying the look and feel of the various documents or content pieces that make up a learning structure. An example of this would be the packaging together of standard content pieces into a single comprehensive document with common look and feel.

(d) The Retrieval Engine is able to select the information or content requirements that are needed to populate the learning structure. It does this by translating the selections made by the user at the access portal and learning structure stages into a relevant tag search.

The core approach used by the retrieval engine is (i) identifying the family of learning structure to which the document is relevant by way of <seeker, context>. (ii) establishing the specific location of the document within the learning structure by specifying the <concept, learning path>. Individual documents or document sets classified on the basis of the universal classification knowledge framework (UCKF). The retrieval engine (which is developed using common computer programming approaches) (a) is ‘told’ who the seeker of the information is and what is the task or ‘knowledge use’ situation at hand (b) selects the appropriate learning structure, which establishes what the context for the data is (c) the user is then able to specify the concept which is sought (d) the retrieval engine is then able to search out all appropriate document clusters and places them within the structure through the ‘description’ provided by the ‘knowledge path’. Based on the above paradigm, UCKF is defined as a tag set comprising of <seeker, context, concept, knowledge path>. Any single document, part of a document or sets of documents which are taggable using current computer technologies and frameworks like XML will then have one or many tags, each of which corresponds to the above UCKF.

Document clusters which together add up to specific types of knowledge interaction (for example—a case study requires not only the case but also responses), are classified using additional tags, which are cluster or cluster class specific. In these situations, specific ‘additional tags’ are created which allow a group of documents to be ordered in the required manner within a cluster.

A preferred embodiment of a system in accordance with the present invention is preferably practiced in the context of a personal computer such as an IBM compatible personal compute, Apple Macintosh computer or UNIX based workstation. A representative hardware environment illustrates a typical hardware configuration of a workstation in accordance with a preferred embodiment having a central processing unit, such as a microprocessor, and a number of other units interconnected via a system bus. The workstation includes a Random Access Memory (RAM), Read Only Memory (ROM), an I/O adapter for connecting peripheral devices such as disk storage units to the bus, a user interface adapter for connecting a keyboard, a mouse, a speaker, a microphone, and/or other user interface devices such as a touch screen (not shown) to the bus, communication adapter for connecting the workstation to a communication network (e.g., a data processing network) and a display adapter for connecting the bus to a display device. The workstation typically has resident thereon an operating system such as the Microsoft Windows NT or Windows/98 Operating System (OS), the IBM OS/2 operating system, the MAC OS, or UNIX operating system. Those skilled in the art will appreciate that the present invention may also be implemented on platforms and operating systems other than those mentioned. A preferred embodiment is written using JAVA, C, and the C++ language, and XML, and further utilizes object oriented programming methodology. Object oriented programming has become increasingly used to develop complex applications.

### EXAMPLE 1

Dothelp

An embodiment of the Visual OOKS Technology Includes:

1. The “dothelp” platform is aimed at enabling a corporation to provide on-line help and advice to its employees, distributors and business partners. The help and advice can be focused around products being sold, company processes, task specific knowledge, or interaction procedures and protocols.

2. At present these needs are being met through websites, which collate, organize and present this knowledge so that the potential users can easily access them using the internet/intranet from anywhere within or outside the company.

3. A critical gap in the current mode of delivery is the additional step, which users have to take in order to convert this knowledge into specific decisions or actions. To elaborate, it is left to individual users to (a) understand their current problem accurately (which is not easy in multifactor situations and problems) (b) state their problem in terms of information requirements (c) translate their information requirements into choice of documents searched/selected. Further, after the documents have been identified, it is left to the user to (i) understand the link between the documents and the problem (ii) go back to the system for further searches as additional aspects of the problem or solution become clearer as a result of the new knowledge gained from these documents.

4. Dothelp meets this critical gap. It does so, by (i) capturing user requirements in the form of specific problem formulations which have been articulated earlier or which are developed along with the user group and (ii) metatagging the knowledge base (which is organized around functions, procedures, product data, etc.) in terms of the UCKF that would be applicable for potential use situations (iii) setting up a retrieval engine which, on being informed of the specific problem formulation searches out, packages and delivers documents across the knowledge base for that particular use (iv) further refinements in dothelp will allow the system to present the documentation in logically linked sequences so that the user is able to also see how various pieces of data within the company link back into his problem formulation.

5. Given below is a description of Dothelp in terms of its user interfaces and tagged documents.

a. the top level (access portal) comprises of the user interfaces which (a) present to the user the activity areas he/she may be currently involved in (b) enables the user to zoom down on the specific problem area within the area of activity. It must be emphasized that the problem areas cut across activity areas and therefore different people engaged in different activities may specify the same problem, but may seek a solution that is slightly differently focused from each other. (See FIG. 5). The system also allows the user to specify his/her requirement in process terms instead of functional terms. This is very valuable to corporations who have built knowledge for many years around functional disciplines but are now expected to perform their activities around business processes and business process software (because of implementing ERP Systems, etc.). This will specify the <SEEKER, context, concept, knowledgepath>

b. The mid level (learning structure layer) comprises of stored learning structures, which establish relationships between documents (or document types). This system will use many learning structures, which are appropriate for different user problem formulations. For example, a ‘how to’ question will trigger off a learning structure which is a operations manual for that task. This manual, which will be developed ‘on the fly’ will combine and present documents related to formats, case studies, etc. in a logical sequence relevant to that question. This will specify the <Seeker, CONTEXT, Concept, Knowledge Path>.

c. Since there are numerous questions, each of which requiring specific combinations of knowledge, it would in practice be quite difficult to go on specifying new concepts as newer answers or learning structures are formulated. In order to enhance the practical use of the system, the developers of the learning structures are encouraged to select pre-defined concepts, which are part of the ‘relational concept taxonomy’ for that work area. This will specify the <Seeker, Context, CONCEPT, Knowledge Path>. Briefly, a taxonomy is proposed of knowledge based on two dimensions instead of one. All taxonomies currently in use, classify knowledge ‘in itself’. The present invention proposes that knowledge is valid only in context/purpose. On this basis the concepts defined for, say finance area in a company, will be on the basis of the units of work or decision points within that company and not on the basis of finance domain in itself. The invention points out that the ‘concept set’ can be commonly defined for any practice group or community of interest and will constitute elements of the taxonomy.

d. The learning structure carries within it specifications for the appropriate kind of document clusters to be retrieved. If the learning structure is meant to deal with the problem of information retrieval, then a whole set of knowledge paths may be treated as appropriate. On the other hand, if the learning structure relates to the construction of study material or class workbooks then the designer of the learning structure will clearly specify the most appropriate type of document cluster to be selected. This will specify the <Seeker, Context, Concept, KNOWLEDGE PATH>. (See FIG. 2).

e. The retrieval engine of the present invention will, on the basis of the specification set, offered by this specific learning structure, search out all documents that will meet the tag set (See FIGS. 4 & 6).

f. The user has a further choice of selecting and reading one of multiple documents that partly or wholly meets the requirements at each logical point within the report (See FIGS. 4 & 6).

6. As the problem set group goes on, increasing documents from within the system will go on getting additionally tagged by the knowledge management team. Further the system allows for documents of all types and media to be integrated and offered in the form of document sets or on-line reports.

The Visual OOKS Technology may also be used to improve retrieval from untagged or very large knowledge bases, by use of the User Centric Search Engine.

### EXAMPLE 2

The User Centric Personal Search Engines:

These are meant to enable users of very large knowledge bases such as the Internet to effectively filter and retrieve documents or web sites that are best suited for the specific task at hand. The User Centric Personal Search Engine has four layers:

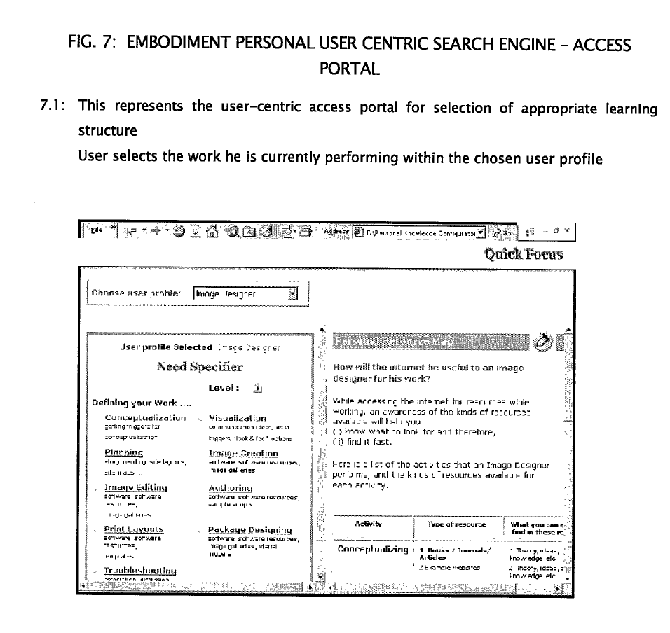

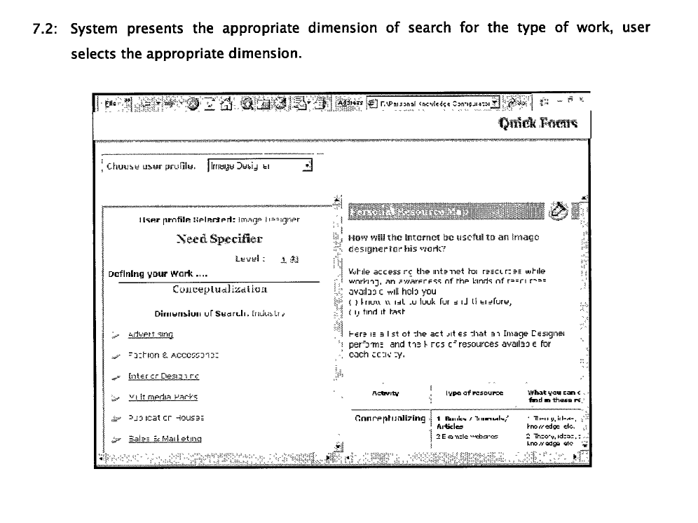

Layer 1—The user interface presents to the user a listing or mapping of the task set in the form of a need specifier, addressed by that specific type of user in day-to-day work. (See FIG. 7.1)

Layer 2—On selection of the appropriate task, the search engine now presents to the user the key work dimensions on which the user can additionally filter out documents. (See FIG. 7.2)

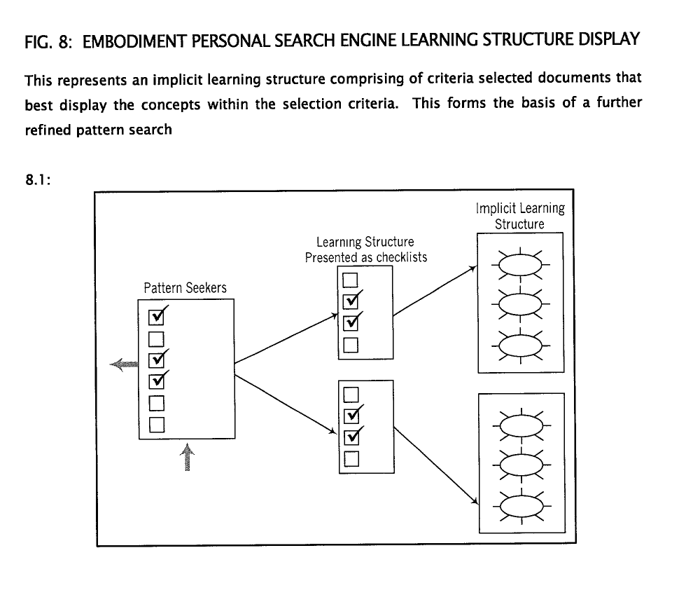

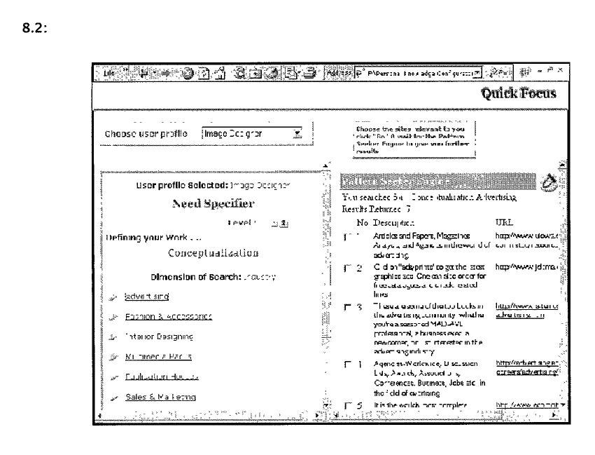

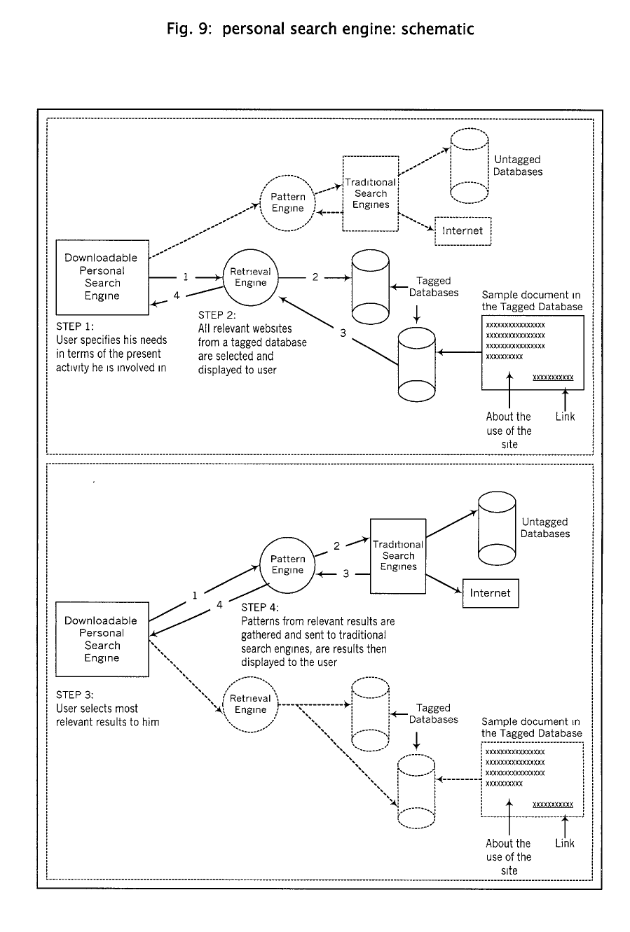

Layer 3—On selection of the additional filter, the search engine will now access a ‘local database’ comprising of a set of tagged documents, which will enable in performing the task and are also representative of the very large database to be accessed. As far as the user is concerned, he or she can see a set of document choices being thrown up immediately (on the basis of the work dimension chosen) (See FIG. 8.2). It will be noticed that the document or website choices offered to the user may also contain a review or description of content in order to enable quicker and more appropriate choices. (If the local database is reasonably large then most of the user requests may be met without accessing the Internet or very large database.)

Layer 4—If the user requests an additional search, the system then selects the ‘normal’ tags on the selected document set (the normal tags would be a keyword set or metatags, etc.). A pattern-matching engine will then identify the most commonly occurring keywords or a selection set of keywords based on any other patterning criteria. Based on the keywords selected, the pattern engine will offer these choices to the ‘regular search engine’ through a small interface program. (See FIGS. 8.1 & 9)

### EXAMPLE 3

Knowledge Router

Another Embodiment of the Visual OOKS Technology

One of the critical trends in the area of information, communications and entertainment is what is popularly called ‘the convergence of media’. In essence, large scale broadband networks are being set up to criss cross the world thereby enabling individual users to access large quantities of content from multiple sources (films, online books, etc.). As in the case with other forms of knowledge, physical access to large quantities of knowledge creates a new problem of ‘information overload’.

A further peculiar problem comes from the merging of two modes of knowledge delivery, which have driven the delivery of knowledge in the past decades. On one hand, television and films have been ‘pushed’ to consumers, with viewers making a choice amongst a set of options. The advent of cable networks have facilitated a dramatic increase in the set of options (in recent years, technologies have been developed, that allow some forms of user interactivity with such a delivery technique). On the other hand, computer delivered data and information has been ‘pulled’ by consumers, with each computer user pulling or selecting the appropriate data through the use of various search techniques, either in closed knowledge systems (such as company data networks) or open systems (such as the internet). The merging of two distinct forms of knowledge delivery is therefore a critical issue to be addressed in the convergence of media.

The ‘Visual OOKS based Knowledge Router’ addresses the critical problem of selecting, pulling and delivering appropriate content to any consumer of knowledge.

The fundamental contribution made by the Visual OOKS technology is that it converts a computer from a knowledge pull device to a knowledge push device. The use of a ‘Disha Grid’ at the front end allows users to in effect, set up their channel (the ‘Disha Grid’ essentially architects the users' ‘experience’ into a number of seeker choices; DISHA is the subject of United States patent application being filed at the same time, Serial No. unassigned).

Based on the channel choice, a learning structure is be offered which essentially provides the framework in which different types of entertainment or work options get related to the user's current specified need (for example, a learning structure that ties in various pieces of content related to cooking in the context of the consumer's current need and experience profile). The learning structure is being built through a structure of concepts. These concepts are being drawn upon a relational taxonomy of cooking knowledge. The final selection made by the consumer is on whether he/she wants to see a short television program or some other form of interactive learning tool related to cooking—this is reflected as a choice in the knowledge path.

The knowledge router described above thus (a) makes use of the Relational Taxonomy, (b) the Disha Grid (subject of a co-pending U.S. Application, Serial No. unassigned), (c) the Visual OOKS Technology.

The knowledge router requires that each piece of content be tagged and stored in a digital medium on the basis of the UCKF. Alternatively, in a manner similar to that described in the user centric search engine, the router may have initial access to a tagged content base and the choices made by the consumer can become the basis for a further ‘conventional search’ using pattern seeking and other technologies.

The physical embodiment of the knowledge router can be in a desktop device or in the computer/television itself. Alternatively, the knowledge router can sit as an integral part or component of a broadband network which uses the DISHA grid as a means to classify its entire set of consumers into seeker sets followed by the delivery of learning structures that will integrate (on a consumer group basis) numerous elements of the content bases to which the network is connected.

### EXAMPLE 4

Flexible Curriculum Design and Delivery of Customized Learning Materials

The approaches used in Visual OOKS Technology can be effectively deployed in the area of flexible curriculum design and delivery of customized learning materials. One of the key problems faced in continuing education, adult learning, and on-going corporate training is teaching people only what they do not know. For example, an engineer with some years of experience will probably already have been exposed to ideas related to quality management. Yet, it is necessary to upgrade the engineer's understanding of the subject. Flexible curriculum design aims to identify precisely what the engineer needs to know to do the job at hand, which then becomes the basis for specifying the gaps in the engineers existing knowledge.

Another application is the development of critical competence curricula. It is found that those students who have not learnt certain fundamental concepts in say, school mathematics, in the earlier grades, suffer from “cascading ignorance” in which their capacity to learn the newer concepts in the next grades become severely impaired, with often highly negative results on learning efficiencies and testing grades. In this application, the use of outcome oriented learning structures as a means to deliver highly directed learning, with the additional advantage of being able to identify precisely the competence gaps that impair capacity to learn, will result in significant improvements in learning efficiencies, not only over conventional syllabi, but also over relatively modern techniques such as concept mapping and mind mapping which are used by educationists to improve learning efficiencies.

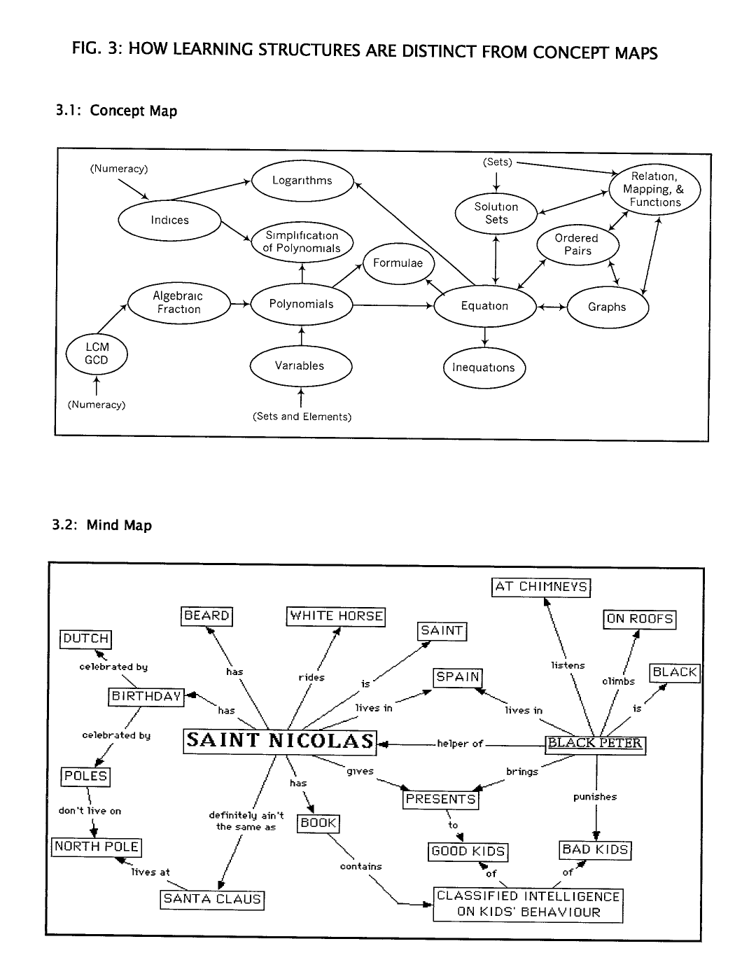

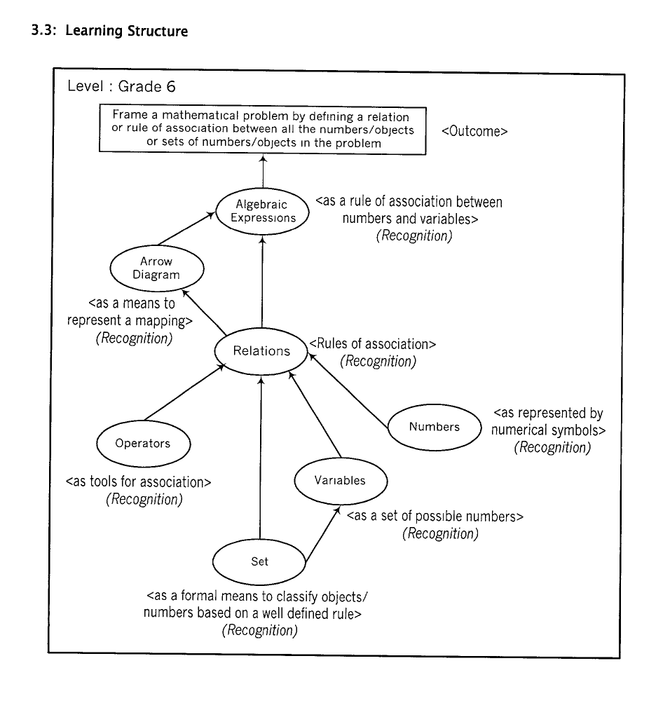

FIG. 3.1 describes a concept map based on inter-linkages using the example of school algebra.

The use of “concepts” have been well known for many years prior, and have been employed by individual teachers, scientists and theorists for better understanding and organization of knowledge.

The objective concept map is predicated on the assumption that a domain of knowledge exists in itself. To enable learning to take place in a flow such that prior knowledge is established before learning about new concepts, the concept map structure is built by taking the topics or “concepts” to be learnt in the subject and building the inter-linkages between them. The concepts and the content within them are fixed depending on the topic and its coverage.

There are advantages to the concept map model of the invention, for example, the concept map structure not only lists the topics to be learnt, but also provides the inter-linkages between the different topics and hence is useful to the user in the sense that he is able to understand the inter-relationships between topics rather than having to learn the topics in isolation. The process of building a concept map by linking related concepts is also useful as a trigger for conceptualizing and lateral thinking.

Notably, the concepts and the content within them are fixed and the concept is more or less rigid 2 dimensional in nature. Moreover, the concept structure, i.e., the inter-linkages between the concepts is also fixed.

This implies that the content of the concepts are a contextual or independent of the user. For example, when one user say a 6th grader learns a concept on say “simplification of polynomials” he sees the same content as an 8th grader learning the same concept. The level of understanding needed to be developed at the two different grades being different, cannot be taken into consideration in the fixed concept. This may lead to either an overload of knowledge to the 6th grader beyond his capability or a repetition of prior knowledge to the 8th grader with no further value added.

Secondly, the concept structure or the inter-linkages between the concepts are fixed. This implies that the user gets a broad understanding of the general existence and placement of a concept, however, he does not have the freedom to explore the concept further. It is observed that each concept itself leads to an infinite hierarchy of multiple sub concepts or a “hypertextuality” of concepts. Since the concept structure is fixed, this hypertextuality cannot be made evident.

For example, the concept of “simplification of polynomials” itself leads to polynomial operations, grouping & distribution, products and expansion, perfect square and cube expansions, difference between two squares and sum and difference between 2 cubes etc. Further perfect square and cube expansions themselves lead to identifies, indices, exponential operations, etc. Hence depending on the starting point of the user, in reality, the concept linkages change. This change is not possible with a fixed structure.

FIG. 3.2 describes a mindmap consisting of central concepts with related ideas.

Mind maps are built based on selection and bring out the “hypertextuality” of concepts, i.e., each concept opens up into a world of sub concepts which further opens into sub concepts and can go on infinitely linking back into all other concepts. This is in general a special form of a web diagram for exploring, gathering and sharing information around topics of subject.

Thus, besides enabling the understanding of a body of knowledge with its interrelationships, this has a flexible concept structure and establishes a “starting point” concept for exploration, which can hyper textually link back into all other concepts. Hence, the user can swim through knowledge concepts infinitely and explore without the restrictions of a fixed concept and structure.

Notably, a mind map is an interconnection of ideas or words without context, Secondly, the “starting point” concept keeps changing depending on the exploration of the user. And finally, the structure itself keeps changing with the hypertext movement.

Mind maps may have same limitations, for example, a mind map is an interconnection of ideas or words with context. This implies that the map is more or less “flat/2D/rigid” versus the multidimensional nature of knowledge, which changes with perspective. For example: The idea “car” could be seen by a traveler, as a mode of transport like a bus or train. The same “car” as seen by a taxi driver would probably be a means of livelihood or as seen by a collector would be a luxury item like an AC, refrigerator etc. Hence the user perspective is not established. Secondly, the mind map also does not solve the problem of different information needs for different users. For example, the information needs of a 6th grader looking at the concept “simplification of polynomials” as a starting point, would have different content needs than an 8th grader looking at the same concept, since the levels of understanding of the concept are different. Hence the user's specific content needs are not taken care of.

An additional limitation of mind maps is that the starting point concept keeps changing depending on the exploration of the user, however, the system is acontextual. Here, the questions that go unanswered are: The concepts themselves can link up infinitely, hence on what basis do you identify and define which concepts should be covered to build the map? Or what is the starting point concept around which map can be built? Or how does the user decide from which concept he should start his learning experience?

Therefore, the process of selecting appropriate concepts, building its linkages, determining the content or knowledge inputs to be populated within each concept, is not a well-defined scientific process, this process is more of an “art” to be created by experts.

The present invention provides a system for building relevant, useful concept maps to aid knowledge management.

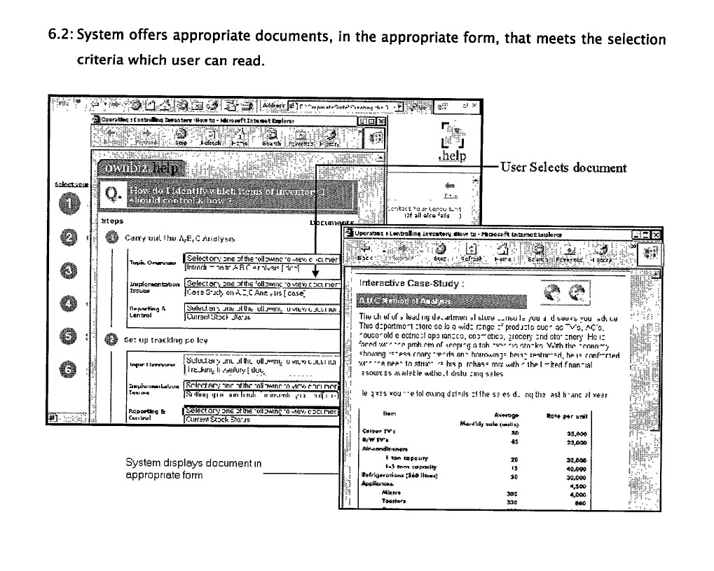

This embodiment is described in FIG. 6

The present invention is not to be limited in scope by the embodiments disclosed in the example which are intended as an illustration of some aspects of the invention and any methods and devices which are functionally equivalent are within the scope of the invention. Indeed, various modifications of the invention in addition to those shown and described herein will become apparent to those skilled in the art from the foregoing description. Such modifications are intended to fall within the scope of the appended claims.

What is claimed is:

1) A visual optimal ordered knowledge system (VISUAL OOKS) comprising:
An access portal used for knowledge seeker's real life outcomes,
A plurality of learning structures used for implementing logical formatting based on combining said outcomes with concepts and knowledge paths,
A knowledge router for selecting content requirements customized to seeker's requirements, said content being selected on the basis of a classification model for knowledge access in general, said model comprising of four set of tags including <seeker, context, concept or knowledge path> (known as UCKF, for Universal Classification Knowledge Framework),
A database used for storing documents and knowledge objects in digital medium of the basis of UCKF, and
Means for the knowledge router to present the customized knowledge objects to the knowledge seeker according to said learning structure and said UCKF, said means including information filtering, digital formatting or physical presentation.

2) The VISUAL OOKS according to claim 1, wherein the plurality of learning structures are built to logically organize the knowledge objects and further define new knowledge objects, such that the knowledge objects are tied to a concept, and said learning structures further comprise:
a) a clearly specified outcome for the learning structure,
b) a set of concepts uniquely defined and organized to meet the specified outcome, and
c) each of said concepts comprising one of more learning paths.

3) A classification model of individual knowledge objects, said model comprising of a set of tags describing:
a) The seeker,
b) The context,
c) The concept, and
d) The knowledge path,
Wherein the classification model represents the knowledge seeker, the type of outcome sought by the knowledge seeker, the specific concept from within a knowledge base, and the type of knowledge object relevant to the outcome sought.

4) The access portal according to claim 1, wherein said access portal presents to users their goals and outcomes sought in the form of hierarchies and maps, thereby enabling the users to specify their requirements.

5) The VISUAL OOKS according to claim 1, wherein the knowledge router enables the logical organization of knowledge objects according to an appropriate learning structure, and said knowledge router is further able to
a) identify the learning structures and concept requirements,
b) build appropriate tags based upon the identification made in (a),
c) search appropriate knowledge objects from a knowledge base, said knowledge objects meeting the identification requirements,
d) logically organize the knowledge objects on the basis of the learning structures,
e) carry out further filtering, selection or search such that the selection and organization of knowledge objects meet the outcome requirements of the learning structure, and
f) enable the users to view, filter, select, print or further organize the knowledge objects for the purpose of knowledge use.

6) The VISUAL OOKS according to claim 1, wherein the system includes a “dothelp platform” used to provide diagnostic help to information seekers.

7) A User Centric Outcome Based Access Engine comprising:
a) a first layer, wherein a user interface presents to the user a listing of tasks typical of the user's day-to-day work,
b) a second layer, wherein, upon selection of an approximate task, a search engine presents to the user a set of key work dimensions to assist the user to further filter out relevant documents,
c) a third layer, wherein the search engine accesses a local database, said database comprising of a set of tagged documents, and said documents being relevant and useful for the user to perform a specific task.

8) The VISUAL OOKS according to claim 5, wherein said knowledge router enables the user to convert a computer from a knowledge-pull device to a knowledge-push device.

9) The VISUAL OOKS according to claim 1, wherein each piece of tagged content is stored in a digital medium on the basis of the UCKF

10) A method of visually optimally ordering knowledge systems (VISUAL OOKS), comprising the knowledge push steps of:
a) presenting to a user a set of choices in terms of goals, outcomes and relationships thereof, and related information, such choices describing the user's real life task and goal requirements.
b) presenting to the user, on the basis of the goal seeking intuitive choices made by the user, the appropriate learning structure from a library of learning structures, which provide a logical and meaningful knowledge based approach for a solution to the user's specified goal or outcome,
c) presenting to the user the appropriate knowledge objects logically organized and filtered such that the appropriate knowledge may be pushed to the user on the basis of the user's specified goal or outcome
d) facilitating the steps above by way of accessing and retrieving a series of information sets or knowledge objects from a tagged database, and
e) facilitating the steps above by way of tagging and storing a large number of information fragments, knowledge objects, or documents in multiple media on the basis of the UCKF such that the system described above is able to select, retrieve, organize, present, and deliver to the user the customized documents appropriately organized, in a logical sequence.

11 ) A method for managing knowledge to customize content for a specific knowledge seeker, said method comprising:
a) tagging individual documents in terms of use, by means of a Universal Classification Knowledge Framework (UCKF).
b) building a set of visual structures to provide access to a body of knowledge, and providing choices within a logical structure in terms of the seeker's context, and
c) allowing selection and linkage of appropriate documents in response to a seeker's request, in a retrieval engine.

12) The method for managing knowledge according to claim 11, further comprising capturing knowledge in terms of a set of knowledge paths and classifying knowledge in terms of “clusters” in a storage and retrieval unit.
